(19) United States
(12) Patent Application Publication
(10) Pub. No.: US 2009/0206776 A1
(43) Pub. Date: Aug. 20, 2009

(54) LED DRIVE CIRCUIT AND LED ILLUMINATION DEVICE USING SAME

(76) Inventor: Katsumi INABA, Tondabayashi-shi (JP)

Correspondence Address: BIRCH STEWART KOLASCH & BIRCH, PO BOX 747, FALLS CHURCH, VA, 22040-0747, US

(21) Appl. No.: 12/389,074

(22) Filed: Feb. 19, 2009

(30) Foreign Application Priority Data
Feb. 20, 2008 (JP) 2008-038592

(51) Int. Cl. H05B 37/02

(52) U.S. Cl. 315/307

(57) ABSTRACT

An LED drive circuit includes a resistor for setting a constant current, a switching power supply circuit for outputting a DC output voltage and a constant-current power supply circuit that receives the DC output voltage and that outputs the constant current to drive the LED. The LED drive circuit reduces, in dim light mode in which the LED is driven by a current less than that in normal light mode, at least one of the oscillation frequencies of an oscillation circuit included in the switching power supply circuit and an oscillation circuit included in the constant-current power supply circuit as compared with the normal light mode.

This nonprovisional application claims priority under 35 U.S.C. §119(a) on Patent Application No. 2008-038592 filed in Japan on Feb. 20, 2008, the entire contents of which are hereby incorporated by reference.

### BACKGROUND OF THE INVENTION

1. Field of the Invention

The present invention relates to an LED (light-emitting diode) drive circuit for driving an LED and an LED illumination device incorporating such an LED drive circuit.

2. Description of Related Art

A conventional technology will be described with reference to FIG. 15. FIG. 15 is a diagram showing an example of the configuration of a conventional illumination LED drive circuit. In the LED drive circuit shown in FIG. 15, an alternating input voltage Vin is full-wave rectified by a diode bridge circuit DB1, and then a primary DC (direct current) input voltage obtained by smoothing the rectified voltage with a smoothing capacitor C1 is converted into a secondary DC output voltage by the use of a switching power supply incorporating an N-channel MOSFET 1, a control circuit 2, a switching transformer T1, a diode D1 and a capacitor C2. Then, in the LED drive circuit shown in FIG. 15, the secondary DC output voltage is detected by resistors R2 and R3, the detection result is fed back to the control circuit 2 via a shunt regulator 3 and a photocoupler composed of a photodiode 4 and a phototransistor 5 and the control circuit 2 controls the duty cycle of the N-channel MOSFET 1 according to the secondary DC output voltage to stabilize the secondary DC output voltage. Moreover, in the LED drive circuit shown in FIG. 15, a constant-current power supply circuit incorporating a driver 6, a diode D2, a coil L1 and a capacitor C3 receives the stabilized secondary DC output voltage, and a constant current set by a resistor R1 is fed to LEDs 7, with the result that the LEDs 7 are driven.

Attempts have been made to achieve more efficient operation of the conventional illumination LED drive circuit in normal light mode using various means. Disadvantageously, however, the conventional illumination LED drive circuit operates inefficiently and increases power loss when it continues to remain in dim light mode (the mode in which LEDs are driven by a current less than that in the normal light mode) for prolonged periods of time such as at night (see paragraph [0002] in JP-T-2003-522393).

### SUMMARY OF THE INVENTION

An object of the present invention is to provide an LED drive circuit that can reduce power loss in dim light mode and an LED illumination device incorporating such an LED drive circuit.

To achieve the above object, according to one aspect of the invention, there is provided an LED drive circuit including a constant current setting portion for setting a constant current. In the LED drive circuit, the constant current is supplied to an LED to drive the LED, and, in dim light mode in which the LED is driven by a current less than that in normal light mode, the oscillation frequency of an oscillation circuit included in the LED drive circuit is reduced as compared with the normal light mode.

With this configuration, since, in the dim light mode, the oscillation frequency of the oscillation circuit included in the LED drive circuit is reduced as compared with the normal light mode, switching loss caused when the oscillation occurs is reduced by an amount corresponding to the reduction in the oscillation frequency. Thus, it is possible to reduce power loss in the dim light mode.

The LED drive circuit may include a switching power supply circuit outputting a DC output voltage and a constant-current power supply circuit that receives the DC output voltage and that outputs the constant current to drive the LED. In the LED drive circuit, in the dim light mode, at least one of oscillation frequencies of an oscillation circuit included in the switching power supply circuit and an oscillation circuit included in the constant-current power supply circuit may be reduced as compared with the normal light mode.

In the LED drive circuit, the dim light mode may be detected by detection of a current passing through the LED.

In the LED drive circuit, the dim light mode may be detected by detection of a current passing through a switching element included in the switching power supply circuit.

In the LED drive circuit, the dim light mode may be detected by detection of an input current to the LED drive circuit.

In the LED drive circuit, the dim light mode may be detected by an external signal.

In the LED drive circuit, the dim light mode may be detected by detection of the amount of light emitted from the LED.

In the dim light mode, the LED drive circuit may operate such that, when the oscillation frequency of the oscillation circuit included in the switching power supply circuit is reduced as compared with the normal light mode, the oscillation frequency of the oscillation circuit included in the constant-current power supply circuit is not reduced, whereas, when the oscillation frequency of the oscillation circuit included in the constant-current power supply circuit is reduced as compared with the normal light mode, the oscillation frequency of the oscillation circuit included in the switching power supply circuit is not reduced.

To achieve the above object, according to another aspect of the present invention, there is provided an LED illumination device incorporating any one of the LED drive circuits described above.

### BRIEF DESCRIPTION OF THE DRAWINGS

FIG. 1 is a diagram showing the configuration of an LED drive circuit according to a first embodiment of the present invention;

FIG. 2 is a diagram showing the configuration of an LED drive circuit according to a second embodiment of the invention;

FIG. 3 is a diagram showing the configuration of an LED drive circuit according to a third embodiment of the invention;

FIG. 4 is a diagram showing the configuration of an LED drive circuit according to a fourth embodiment of the invention;

FIG. 5 is a diagram showing the configuration of an LED drive circuit according to a fifth embodiment of the invention;

FIG. 6 is a diagram showing the configuration of an LED drive circuit according to a sixth embodiment of the invention;

FIG. 7 is a diagram showing the configuration of an LED drive circuit according to a seventh embodiment of the invention;

FIG. 8 is a diagram showing the configuration of an LED drive circuit according to an eighth embodiment of the invention;

FIG. 9 is a diagram showing the configuration of an LED drive circuit according to a ninth embodiment of the invention;

FIG. 10 is a diagram showing the configuration of an LED drive circuit according to a tenth embodiment of the invention;

FIG. 11 is a diagram showing the configuration of an LED drive circuit according to an eleventh embodiment of the invention;

FIG. 12 is a diagram showing the configuration of an LED drive circuit according to a twelfth embodiment of the invention;

FIG. 13 is a diagram showing an example of the configuration of a control circuit that can vary the frequency of an oscillation circuit included therein;

FIG. 14 is a diagram showing an example of the configuration of a driver that can vary the frequency of an oscillation circuit included therein; and

FIG. 15 is a diagram showing an example of the configuration of a conventional illumination LED drive circuit.

### DETAILED DESCRIPTION OF PREFERRED EMBODIMENTS

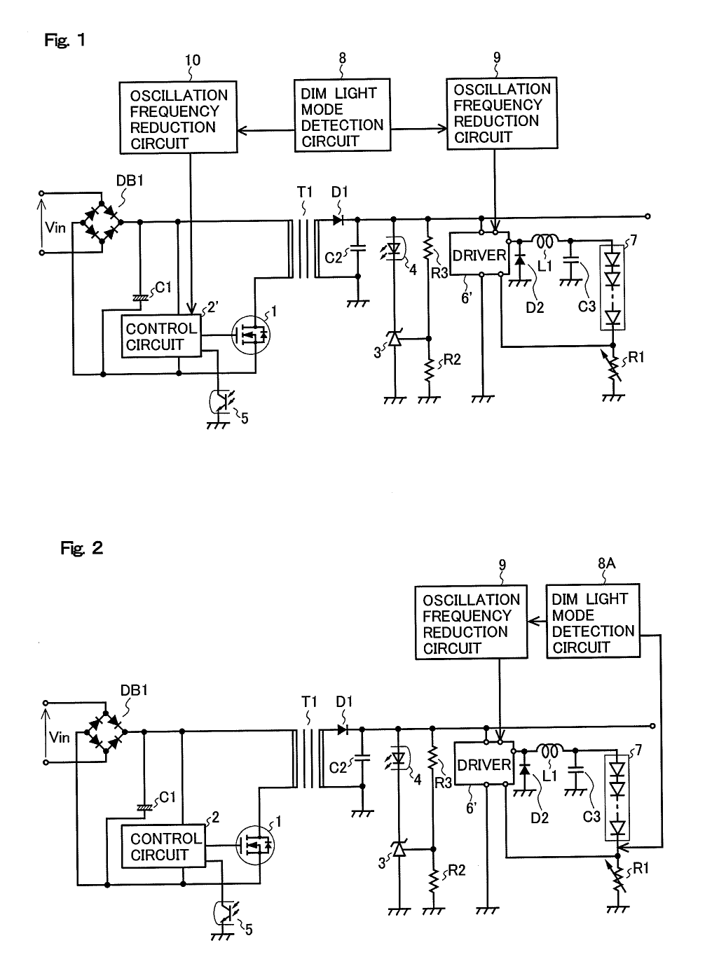

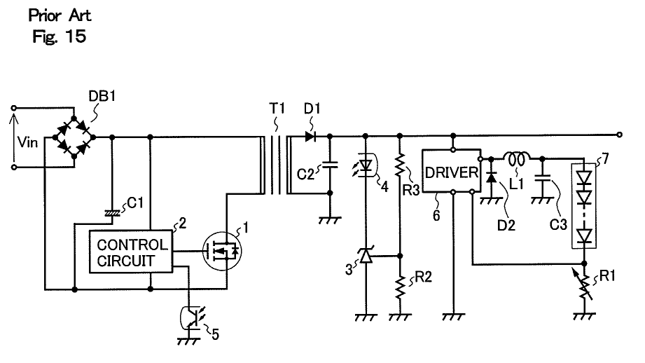

A first embodiment of the present invention will first be described with reference to FIG. 1. FIG. 1 is a diagram showing the configuration of an LED drive circuit according to the first embodiment of the invention. In FIG. 1, such parts as are found also in FIG. 15 are identified with common reference numerals and their detailed description will not be repeated.

The LED drive circuit shown in FIG. 1 differs from that shown in FIG. 15 in that the control circuit 2 is replaced with a control circuit 2′ that can vary the oscillation frequency of an oscillation circuit (not shown) included therein, the driver 6 is replaced with a driver 6′ that can vary the oscillation frequency of an oscillation circuit (not shown) included therein and a dim light mode detection circuit 8 and oscillation frequency reduction circuits 9 and 10 are further provided. The dim light mode detection circuit 8 is a circuit that detects dim light mode. The oscillation frequency reduction circuit 9 is a circuit that reduces, when the dim light mode is detected by the dim light mode detection circuit 8, the oscillation frequency of the oscillation circuit included in the driver 6′ as compared with the normal light mode. The oscillation frequency reduction circuit 10 is a circuit that reduces, when the dim light mode is detected by the dim light mode detection circuit 8, the oscillation frequency of the oscillation circuit included in the control circuit 2′ as compared with the normal light mode.

With this configuration, since, in the dim light mode, the oscillation frequencies of the oscillation circuits included in the control circuit 2′ and the driver 6′ are reduced as compared with the normal light mode, switching loss caused when the oscillation occurs is reduced by an amount corresponding to the reduction in the oscillation frequencies. Thus, it is possible to reduce power loss in the dim light mode.

A second embodiment of the present invention will now be described with reference to FIG. 2. FIG. 2 is a diagram showing the configuration of an LED drive circuit according to the second embodiment of the invention. In FIG. 2, such parts as are found also in FIG. 15 are identified with common reference numerals and their detailed description will not be repeated.

The LED drive circuit shown in FIG. 2 differs from that shown in FIG. 15 in that the driver 6 is replaced with the driver 6′ that can vary the oscillation frequency of the oscillation circuit (not shown) included therein and a dim light mode detection circuit 8A and the oscillation frequency reduction circuit 9 are further provided. The dim light mode detection circuit 8A is a circuit that detects a current passing through the LEDs 7 to detect the dim light mode; specifically, it detects the dim light mode when the current through the LEDs 7 falls within a predetermined range (an LED current range corresponding to the dim light mode). The oscillation frequency reduction circuit 9 is a circuit that reduces, when the dim light mode is detected by the dim light mode detection circuit 8A, the oscillation frequency of the oscillation circuit included in the driver 6′ as compared with the normal light mode.

With this configuration, since, in the dim light mode, the oscillation frequency of the oscillation circuit included in the driver 6′ is reduced as compared with the normal light mode, switching loss caused when the oscillation occurs is reduced by an amount corresponding to the reduction in the oscillation frequency. Thus, it is possible to reduce power loss in the dim light mode.

A third embodiment of the present invention will now be described with reference to FIG. 3. FIG. 3 is a diagram showing the configuration of an LED drive circuit according to the third embodiment of the invention. In FIG. 3, such parts as are found also in FIG. 15 are identified with common reference numerals and their detailed description will not be repeated.

The LED drive circuit shown in FIG. 3 differs from that shown in FIG. 15 in that the driver 6 is replaced with the driver 6′ that can vary the oscillation frequency of the oscillation circuit (not shown) included therein and a dim light mode detection circuit 8B and the oscillation frequency reduction circuit 9 are further provided. The dim light mode detection circuit 8B is a circuit that detects a current passing through the N-channel MOSFET 1 to detect the dim light mode; specifically, it detects the dim light mode when the current through the N-channel MOSFET 1 falls within a predetermined range (a MOSFET current range corresponding to the dim light mode). The oscillation frequency reduction circuit 9 is a circuit that reduces, when the dim light mode is detected by the dim light mode detection circuit 8B, the oscillation frequency of the oscillation circuit included in the driver 6′ as compared with the normal light mode.

With this configuration, since, in the dim light mode, the oscillation frequency of the oscillation circuit included in the driver 6′ is reduced as compared with the normal light mode, switching loss caused when the oscillation occurs is reduced by an amount corresponding to the reduction in the oscillation frequency. Thus, it is possible to reduce power loss in the dim light mode.

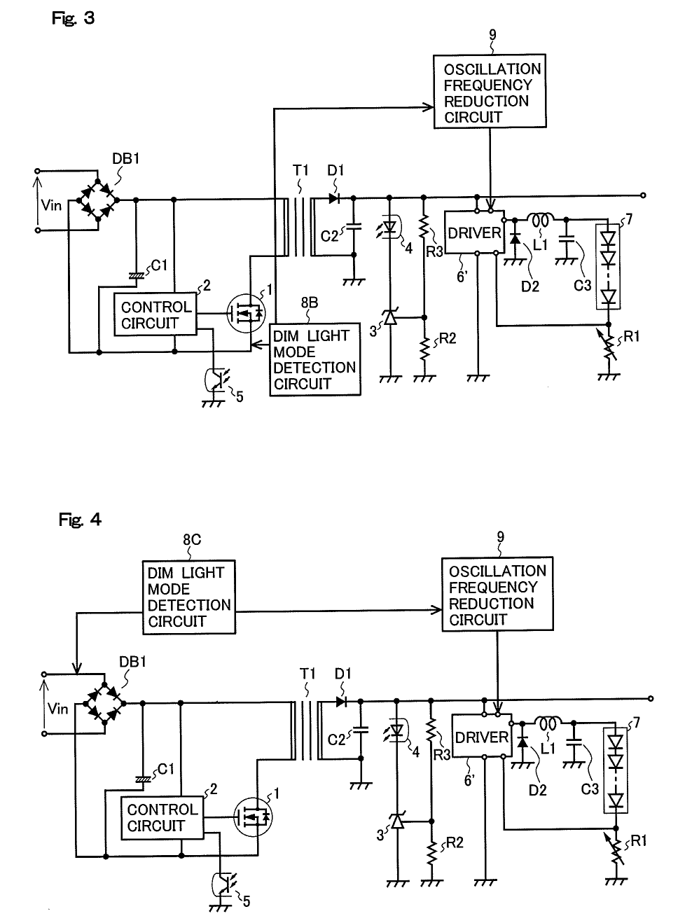

A fourth embodiment of the present invention will now be described with reference to FIG. 4. FIG. 4 is a diagram showing the configuration of an LED drive circuit according to the fourth embodiment of the invention. In FIG. 4, such parts as are found also in FIG. 15 are identified with common reference numerals and their detailed description will not be repeated.

The LED drive circuit shown in FIG. 4 differs from that shown in FIG. 15 in that the driver 6 is replaced with the driver 6′ that can vary the oscillation frequency of the oscillation circuit (not shown) included therein and a dim light mode detection circuit 8C and the oscillation frequency reduction circuit 9 are further provided. The dim light mode detection circuit 8C is a circuit that detects the input current of the LED drive circuit shown in FIG. 4 to detect the dim light mode; specifically, it detects the dim light mode when the input current (root-mean-square value) of the LED drive circuit shown in FIG. 4 falls within a predetermined range (an input current range corresponding to the dim light mode). The oscillation frequency reduction circuit 9 is a circuit that reduces, when the dim light mode is detected by the dim light mode detection circuit 8C, the oscillation frequency of the oscillation circuit included in the driver 6′ as compared with the normal light mode.

With this configuration, since, in the dim light mode, the oscillation frequency of the oscillation circuit included in the driver 6′ is reduced as compared with the normal light mode, switching loss caused when the oscillation occurs is reduced by an amount corresponding to the reduction in the oscillation frequency. Thus, it is possible to reduce power loss in the dim light mode.

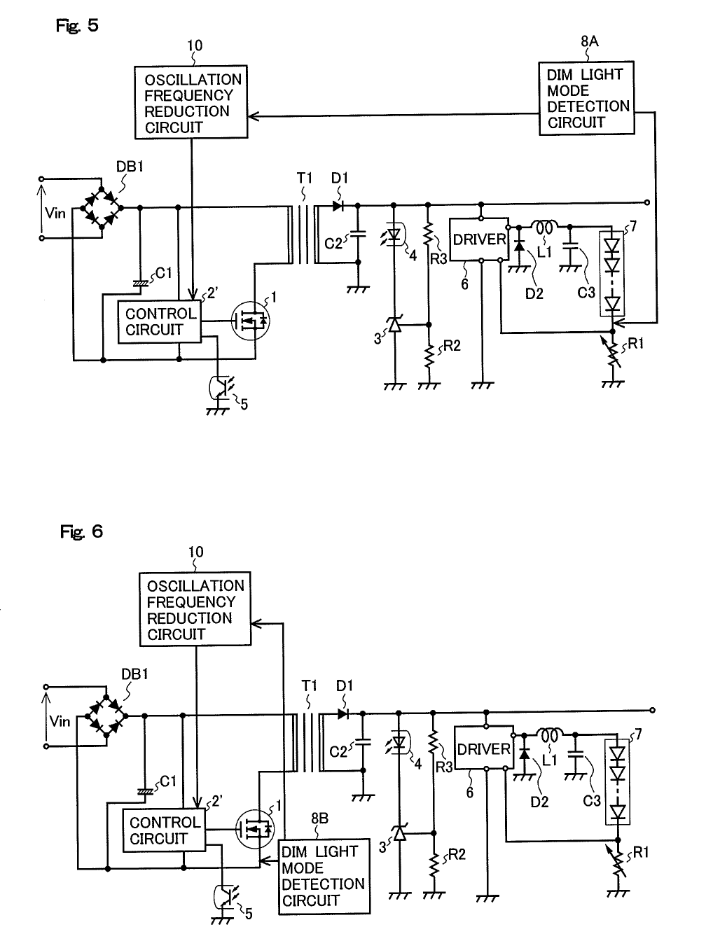

A fifth embodiment of the present invention will now be described with reference to FIG. 5. FIG. 5 is a diagram showing the configuration of an LED drive circuit according to the fifth embodiment of the invention. In FIG. 5, such parts as are found also in FIG. 15 are identified with common reference numerals and their detailed description will not be repeated.

The LED drive circuit shown in FIG. 5 differs from that shown in FIG. 15 in that the control circuit 2 is replaced with the control circuit 2′ that can vary the oscillation frequency of the oscillation circuit (not shown) included therein and the dim light mode detection circuit 8A and the oscillation frequency reduction circuit 10 are further provided. The dim light mode detection circuit 8A is a circuit that detects the current passing through the LEDs 7 to detect the dim light mode; specifically, it detects the dim light mode when the current through the LEDs 7 falls within the predetermined range (the LED current range corresponding to the dim light mode). The oscillation frequency reduction circuit 10 is a circuit that reduces, when the dim light mode is detected by the dim light mode detection circuit 8A, the oscillation frequency of the oscillation circuit included in the control circuit 2′ as compared with the normal light mode.

With this configuration, since, in the dim light mode, the oscillation frequency of the oscillation circuit included in the control circuit 2′ is reduced as compared with the normal light mode, switching loss caused when the oscillation occurs is reduced by an amount corresponding to the reduction in the oscillation frequency. Thus, it is possible to reduce power loss in the dim light mode.

A sixth embodiment of the present invention will now be described with reference to FIG. 6. FIG. 6 is a diagram showing the configuration of an LED drive circuit according to the sixth embodiment of the invention. In FIG. 6, such parts as are found also in FIG. 15 are identified with common reference numerals and their detailed description will not be repeated.

The LED drive circuit shown in FIG. 6 differs from that shown in FIG. 15 in that the control circuit 2 is replaced with the control circuit 2′ that can vary the oscillation frequency of the oscillation circuit (not shown) included therein and the dim light mode detection circuit 8B and the oscillation frequency reduction circuit 10 are further provided. The dim light mode detection circuit 8B is a circuit that detects the current passing through the N-channel MOSFET 1 to detect the dim light mode; specifically, it detects the dim light mode when the current through the N-channel MOSFET 1 falls within the predetermined range (the MOSFET current range corresponding to the dim light mode). The oscillation frequency reduction circuit 10 is a circuit that reduces, when the dim light mode is detected by the dim light mode detection circuit 8B, the oscillation frequency of the oscillation circuit included in the control circuit 2′ as compared with the normal light mode.

With this configuration, since, in the dim light mode, the oscillation frequency of the oscillation circuit included in the control circuit 2′ is reduced as compared with the normal light mode, switching loss caused when the oscillation occurs is reduced by an amount corresponding to the reduction in the oscillation frequency. Thus, it is possible to reduce power loss in the dim light mode.

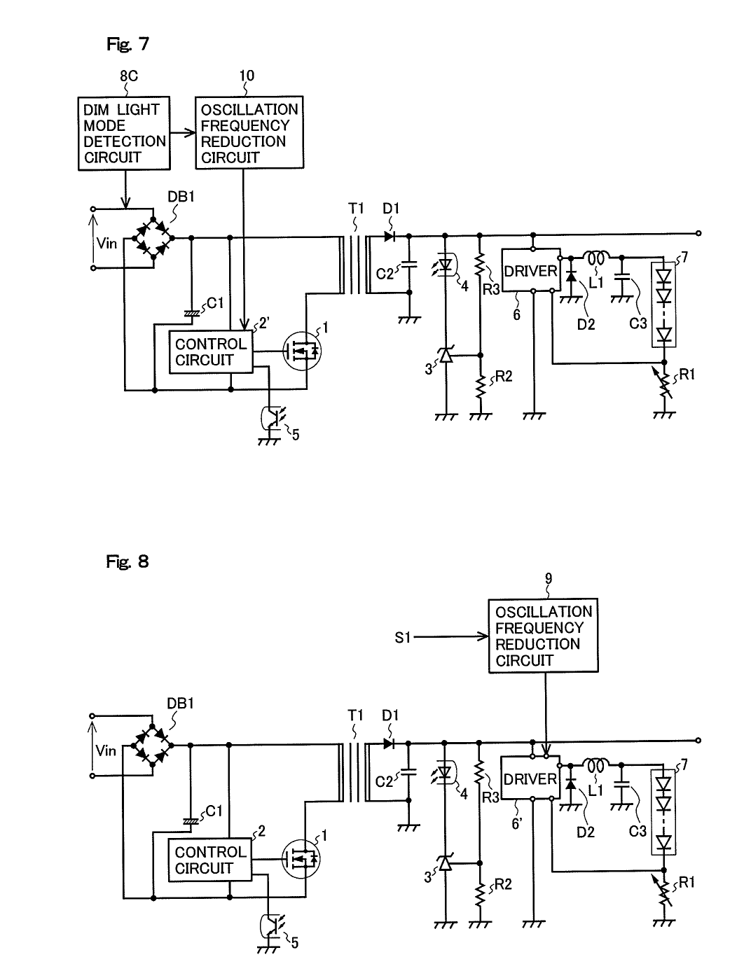

A seventh embodiment of the present invention will now be described with reference to FIG. 7. FIG. 7 is a diagram showing the configuration of an LED drive circuit according to the seventh embodiment of the invention. In FIG. 7, such parts as are found also in FIG. 15 are identified with common reference numerals and their detailed description will not be repeated.

The LED drive circuit shown in FIG. 7 differs from that shown in FIG. 15 in that the control circuit 2 is replaced with the control circuit 2′ that can vary the oscillation frequency of the oscillation circuit (not shown) included therein and the dim light mode detection circuit 8C and the oscillation frequency reduction circuit 10 are further provided. The dim light mode detection circuit 8C is a circuit that detects the input current of the LED drive circuit shown in FIG. 7 to detect the dim light mode; specifically, it detects the dim light mode when the input current (root-mean-square value) of the LED drive circuit shown in FIG. 7 falls within the predetermined range (the input current range corresponding to the dim light mode). The oscillation frequency reduction circuit 10 is a circuit that reduces, when the dim light mode is detected by the dim light mode detection circuit 8C, the oscillation frequency of the oscillation circuit included in the control circuit 2′ as compared with the normal light mode.

With this configuration, since, in the dim light mode, the oscillation frequency of the oscillation circuit included in the control circuit 2′ is reduced as compared with the normal light mode, switching loss caused when the oscillation occurs is reduced by an amount corresponding to the reduction in the oscillation frequency. Thus, it is possible to reduce power loss in the dim light mode.

An eighth embodiment of the present invention will now be described with reference to FIG. 8. FIG. 8 is a diagram showing the configuration of an LED drive circuit according to the eighth embodiment of the invention. In FIG. 8, such parts as are found also in FIG. 15 are identified with common reference numerals and their detailed description will not be repeated.

The LED drive circuit shown in FIG. 8 differs from that shown in FIG. 15 in that the driver 6 is replaced with the driver 6′ that can vary the oscillation frequency of the oscillation circuit (not shown) included therein and the oscillation frequency reduction circuit 9 is further provided. The oscillation frequency reduction circuit 9 is a circuit that reduces, when receiving an external signal S1 that is fed from a microcomputer or the like (not shown) and that indicates the dim light mode, the oscillation frequency of the oscillation circuit included in the driver 6′ as compared with the normal light mode.

With this configuration, since, in the dim light mode, the oscillation frequency of the oscillation circuit included in the driver 6′ is reduced as compared with the normal light mode, switching loss caused when the oscillation occurs is reduced by an amount corresponding to the reduction in the oscillation frequency. Thus, it is possible to reduce power loss in the dim light mode.

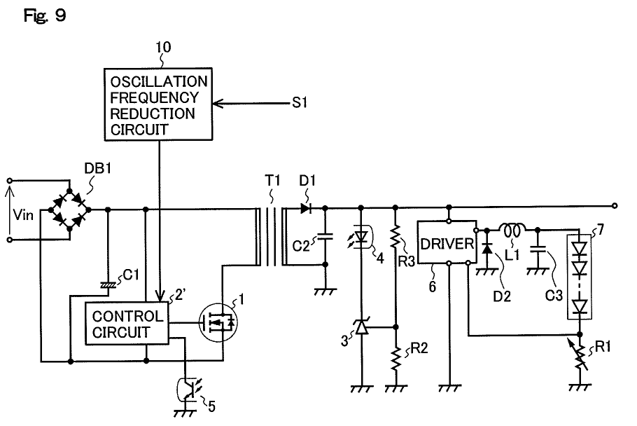

A ninth embodiment of the present invention will now be described with reference to FIG. 9. FIG. 9 is a diagram showing the configuration of an LED drive circuit according to the ninth embodiment of the invention. In FIG. 9, such parts as are found also in FIG. 15 are identified with common reference numerals and their detailed description will not be repeated.

The LED drive circuit shown in FIG. 9 differs from that shown in FIG. 15 in that the control circuit 2 is replaced with the control circuit 2′ that can vary the oscillation frequency of the oscillation circuit (not shown) included therein and the oscillation frequency reduction circuit 10 is further provided. The oscillation frequency reduction circuit 10 is a circuit that reduces, when receiving the external signal S1 that is fed from a microcomputer or the like (not shown) and that indicates the dim light mode, the oscillation frequency of the oscillation circuit included in the control circuit 2′ as compared with the normal light mode.

With this configuration, since, in the dim light mode, the oscillation frequency of the oscillation circuit included in the control circuit 2′ is reduced as compared with the normal light mode, switching loss caused when the oscillation occurs is reduced by an amount corresponding to the reduction in the oscillation frequency. Thus, it is possible to reduce power loss in the dim light mode.

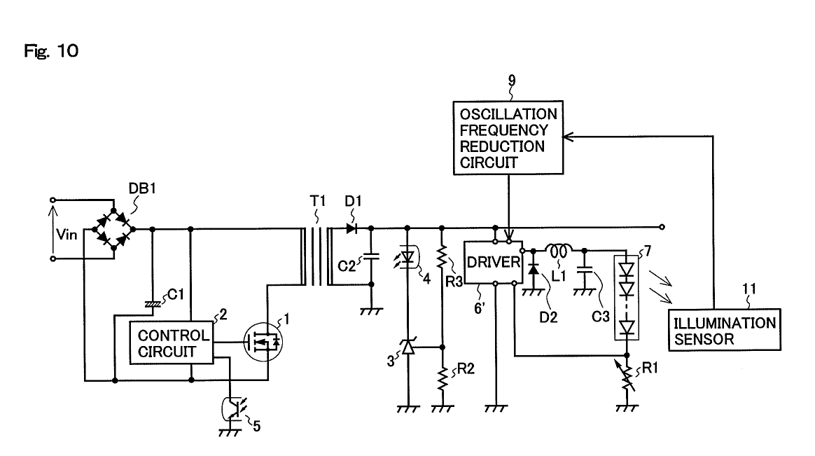

A tenth embodiment of the present invention will now be described with reference to FIG. 10. FIG. 10 is a diagram showing the configuration of an LED drive circuit according to the tenth embodiment of the invention. In FIG. 10, such parts as are found also in FIG. 15 are identified with common reference numerals and their detailed description will not be repeated.

The LED drive circuit shown in FIG. 10 differs from that shown in FIG. 15 in that the driver 6 is replaced with the driver 6′ that can vary the oscillation frequency of the oscillation circuit (not shown) included therein and an illumination sensor 11 and the oscillation frequency reduction circuit 9 are further provided. The illumination sensor 11 is a circuit that detects the amount of light emitted from the LEDs 7. The oscillation frequency reduction circuit 9 is a circuit that reduces, when the amount of light emitted from the LEDs 7 and detected by the illumination sensor 11 falls within a predetermined range (an LED light amount range corresponding to the dim light mode), the oscillation frequency of the oscillation circuit included in the driver 6′ as compared with the normal light mode.

With this configuration, since, in the dim light mode, the oscillation frequency of the oscillation circuit included in the driver 6′ is reduced as compared with the normal light mode, switching loss caused when the oscillation occurs is reduced by an amount corresponding to the reduction in the oscillation frequency. Thus, it is possible to reduce power loss in the dim light mode.

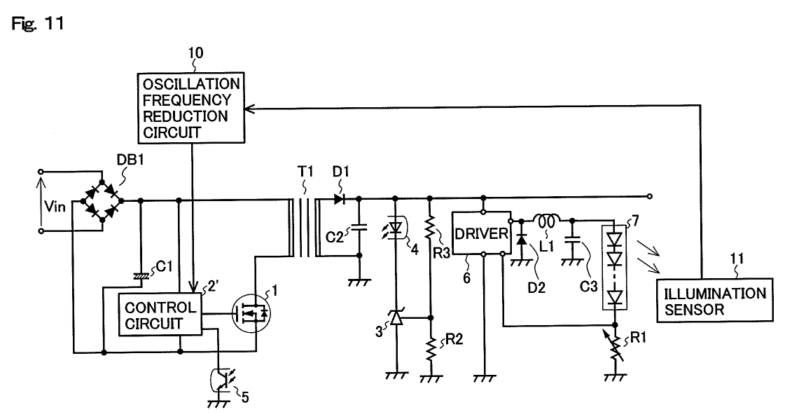

An eleventh embodiment of the present invention will now be described with reference to FIG. 11. FIG. 11 is a diagram showing the configuration of an LED drive circuit according to the eleventh embodiment of the invention. In FIG. 1, such parts as are found also in FIG. 15 are identified with common reference numerals and their detailed description will not be repeated.

The LED drive circuit shown in FIG. 11 differs from that shown in FIG. 15 in that the control circuit 2 is replaced with the control circuit 2′ that can vary the oscillation frequency of the oscillation circuit (not shown) included therein and the illumination sensor 11 and the oscillation frequency reduction circuit 10 are further provided. The illumination sensor 11 is a circuit that detects the amount of light emitted from the LEDs 7. The oscillation frequency reduction circuit 10 is a circuit that reduces, when the amount of light emitted from the LEDs 7 and detected by the illumination sensor 11 falls within the predetermined range (the LED light amount range corresponding to the dim light mode), the oscillation frequency of the oscillation circuit included in the control circuit 2′ as compared with the normal light mode.

With this configuration, since, in the dim light mode, the oscillation frequency of the oscillation circuit included in the control circuit 2′ is reduced as compared with the normal light mode, switching loss caused when the oscillation occurs is reduced by an amount corresponding to the reduction in the oscillation frequency. Thus, it is possible to reduce power loss in the dim light mode.

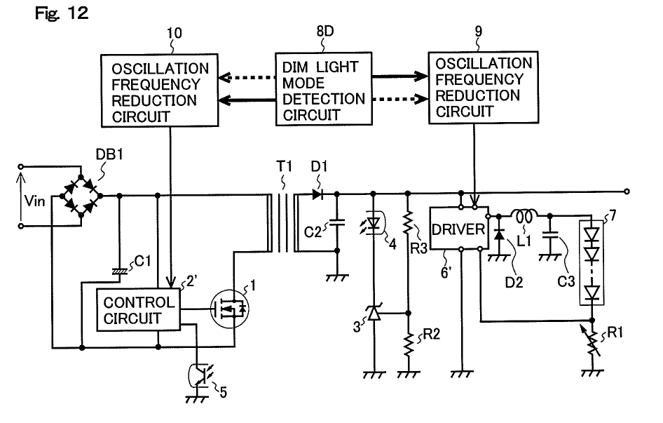

A twelfth embodiment of the present invention will now be described with reference to FIG. 12. FIG. 12 is a diagram showing the configuration of an LED drive circuit according to the twelfth embodiment of the invention. In FIG. 12, such parts as are found also in FIG. 15 are identified with common reference numerals and their detailed description will not be repeated.

The LED drive circuit shown in FIG. 12 differs from that shown in FIG. 15 in that the control circuit 2 is replaced with the control circuit 2′ that can vary the oscillation frequency of the oscillation circuit (not shown) included therein, the driver 6 is replaced with the driver 6′ that can vary the oscillation frequency of the oscillation circuit (not shown) included therein and a dim light mode detection circuit 8D and the oscillation frequency reduction circuits 9 and 10 are further provided. The dim light mode detection circuit 8D is a circuit that detects the dim light mode; when it detects the dim light mode, if it activates the oscillation frequency reduction circuit 9, it does not activate the oscillation frequency reduction circuit 10, whereas, if it activates the oscillation frequency reduction circuit 10, it does not activate the oscillation frequency reduction circuit 9. The oscillation frequency reduction circuit 9 is a circuit that reduces, when it is instructed by the dim light mode detection circuit 8D to operate, the oscillation frequency of the oscillation circuit included in the diver 6′ as compared with the normal light mode. The oscillation frequency reduction circuit 10 is a circuit that reduces, when it is instructed by the dim light mode detection circuit 8D to operate, the oscillation frequency of the oscillation circuit included in the control circuit 2′ as compared with the normal light mode.

Like the above-described LED drive circuit according to the first embodiment and shown in FIG. 1, if, in the dim light mode, the oscillation frequencies of the oscillation circuits included in the control circuit 2′ and the driver 6′ are reduced as compared with the normal light mode, it is likely that an interference phenomenon occurs and power supply operation becomes unstable. On the other hand, in the dim light mode, the LED drive circuit according to this embodiment and shown in FIG. 12 does not reduce, when reducing the oscillation frequency of the oscillation circuit included in the control circuit 2′ as compared with the normal light mode, the oscillation frequency of the oscillation circuit included in the driver 6′, whereas it does not reduce, when reducing the oscillation frequency of the oscillation circuit included in the driver 6′ as compared with the normal light mode, the oscillation frequency of the oscillation circuit included in the control circuit 2′; this eliminates the possibility that an interference phenomenon occurs and power supply operation becomes unstable. When the LED drive circuit according to this embodiment and shown in FIG. 12 is in the dim light mode, switching loss caused when the oscillation occurs is reduced by an amount corresponding to the reduction in the oscillation frequency of the oscillation circuit. Thus, it is possible to reduce power loss in the dim light mode.

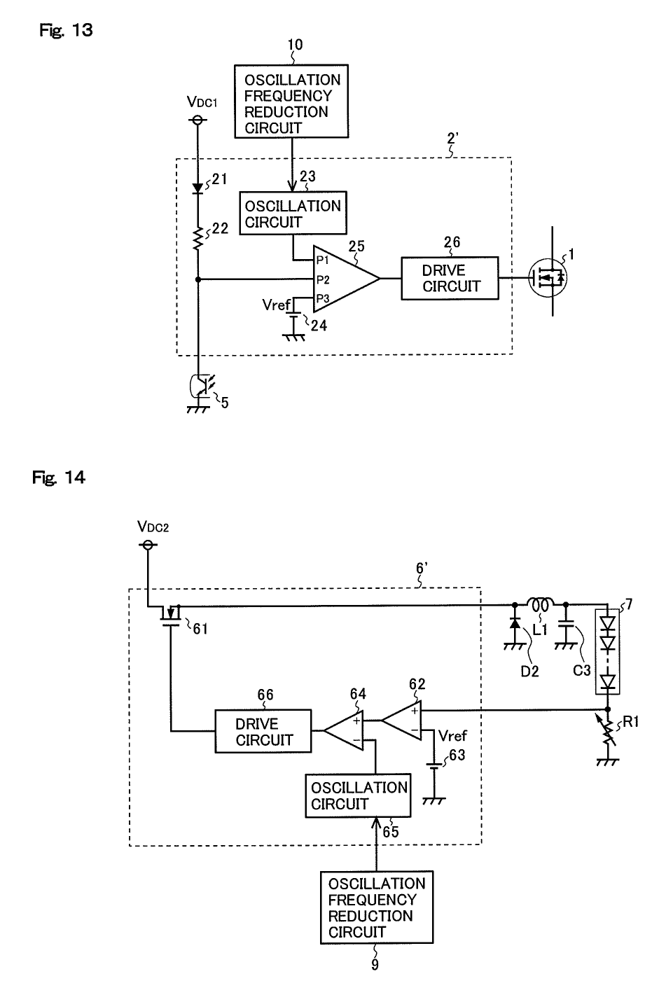

The configurations of the control circuit 2′ that can vary the oscillation frequency of the oscillation circuit included therein and the driver 6′ that can vary the oscillation frequency of the oscillation circuit included therein will now be described. An example of the configuration of the control circuit 2′ is shown in FIG. 13; an example of the configuration of the driver 6′ is shown in FIG. 14. In FIGS. 13 and 14, such parts as are found also in FIG. 1 are identified with common reference numerals and their detailed description will not be repeated.

The control circuit 2′ shown in FIG. 13 includes: a diode 21 having a primary DC input voltage V_{DC1} (for example, a voltage obtained by full-wave rectifying an alternating input voltage Vin shown in FIG. 1 with a diode bridge circuit DB1 and then smoothing the rectified voltage with a smoothing capacitor C1) applied to its anode; a pull-up resistor 22; an oscillation circuit 23; a reference voltage source 24; a PWM comparator 25; and a drive circuit 26.

An oscillation signal output from the oscillation circuit 23 is input to the first input terminal P1 of the PWM comparator 25. A voltage at a node between the pull-up resistor 22 and a phototransistor 5 is input to the second input terminal P2 of the PWM comparator 25. A reference voltage Vref supplied from the reference voltage source 24 is input to the third input terminal P3 of the PWM comparator 25. Every time the oscillation signal is output from the oscillation circuit 23, the PWM comparator 25 produces a PWM output having a pulse width corresponding to which of the voltage input to the second input terminal P2 and the voltage input to the third input terminal P3 is lower. The drive circuit 26 receives the PWM output of the PWM comparator 25 and feeds a pulse signal corresponding to the PWM output to the gate of the N-channel MOSFET 1 to turn on and off the N-channel MOSFET 1.

The oscillation circuit 23 is controlled by the oscillation frequency reduction circuit 10 to, for example, switch the time constant to vary the oscillation frequency.

The driver 6′ shown in FIG. 14 includes an N-channel MOSFET 61, an error amplifier 62, a reference voltage source 63, a PWM comparator 64, an oscillation circuit 65 and a drive circuit 66.

Since the drive circuit 66 turns on and off the N-channel MOSFET 61, a constant-current power supply circuit including the driver 6′, a diode D2, a coil L1 and a capacitor C3 generates a voltage obtained by stepping down a secondary DC output voltage V_{DC2} (for example, the output voltage of a switching power supply including the N-channel MOSFET 1, the control circuit 2′, a switching transformer T1, a diode D1 and a capacitor C2 shown in FIG. 1) at the both ends of the capacitor C3, with the result that the LEDs 7 are driven.

A voltage obtained by multiplying the current passing through the LEDs 7 by the resistance of the resistor R1 is fed to the non-inverting input terminal of the error amplifier 62, and is compared with the reference voltage Vref fed from the reference voltage source 63 to the inverting input terminal of the error amplifier 62. Thus, a voltage corresponding to the voltage difference between the two input terminals appears at the output of the error amplifier 62, and this voltage is fed to the non-inverting input terminal of the PWM comparator 64.

A sawtooth signal output from the oscillation circuit 65 is input to the inverting input terminal of the PWM comparator 64, and is compared by the PWM comparator 64 with the output voltage level of the error amplifier 62. Consequently, during which the output voltage level of the error amplifier 62 is higher than the voltage level of the sawtooth signal, the PWM output of the PWM comparator 64 is held high; during which the output voltage level of the error amplifier 62 is lower than the voltage level of the sawtooth signal, the PWM output of the PWM comparator 64 is held low.

Then, the drive circuit 66 receives the PWM output of the PWM comparator 64, and feeds a pulse signal corresponding to the PWM output to the gate of the N-channel MOSFET 61 to turn on and off the N-channel MOSFET 61. Specifically, when the PWM output of the PWM comparator 64 is high, the drive circuit 66 supplies a predetermined gate voltage to the N-channel MOSFET 61 to turn on the N-channel MOSFET 61. In contrast, when the PWM output of the PWM comparator 64 is low, the drive circuit 66 does not supply the predetermined gate voltage to the N-channel MOSFET 61 to turn off the N-channel MOSFET 61.

The drive circuit 66 controls the turning on and off of the N-channel MOSFET 61 as described above, that is, performs the operation of controlling the switching. In this way, a step-down operation is so performed as to eliminate the voltage difference between the two input terminals of the error amplifier 62. The current passing through the LEDs 7 is then stabilized at a current obtained by dividing the reference voltage Vref by the resistance of the resistor R1.

The oscillation circuit 65 is controlled by the oscillation frequency reduction circuit 9 to, for example, switch the time constant to vary the oscillation frequency.

Finally, an LED illumination device according to the present invention will be described. In an example of the configuration of the LED illumination device of the invention, any one of the LED drive circuits of FIGS. 1 to 12 and the LEDs 7 driven by such an LED drive circuit are included, and illumination LEDs are used as the LEDs 7. With this configuration, it is possible to provide an LED illumination device with low power consumption in the dim light mode.

What is claimed is:

1. An LED drive circuit comprising:
a constant current setting portion for setting a constant current,
wherein the constant current is supplied to an LED to drive the LED, and, in dim light mode in which the LED is driven by a current less than a current in normal light mode, an oscillation frequency of an oscillation circuit included in the LED drive circuit is reduced as compared with the normal light mode.

2. The LED drive circuit of claim 1, further comprising:
a switching power supply circuit outputting a DC output voltage; and
a constant-current power supply circuit that receives the DC output voltage and that outputs the constant current to drive the LED,
wherein, in the dim light mode, at least one of oscillation frequencies of an oscillation circuit included in the switching power supply circuit and an oscillation circuit included in the constant-current power supply circuit is reduced as compared with the normal light mode.

3. The LED drive circuit of claim 1,
wherein the dim light mode is detected by detection of a current passing through the LED.

4. The LED drive circuit of claim 1,
wherein the dim light mode is detected by detection of an input current to the LED drive circuit.

5. The LED drive circuit of claim 1,
wherein the dim light mode is detected by an external signal.

6. The LED drive circuit of claim 1,
wherein the dim light mode is detected by detection of an amount of light emitted from the LED.

7. The LED drive circuit of claim 2,
wherein the dim light mode is detected by detection of a current passing through a switching element included in the switching power supply circuit.

8. The LED drive circuit of claim 2,
wherein, in the dim light mode, when the oscillation frequency of the oscillation circuit included in the switching power supply circuit is reduced as compared with the normal light mode, the oscillation frequency of the oscillation circuit included in the constant-current power supply circuit is not reduced, whereas, when the oscillation frequency of the oscillation circuit included in the constant-current power supply circuit is reduced as compared with the normal light mode, the oscillation frequency of the oscillation circuit included in the switching power supply circuit is not reduced.

9. An LED illumination device comprising:
an LED drive circuit,
wherein the LED drive circuit includes a constant current setting portion for setting a constant current, supplies the constant current to an LED to drive the LED and reduces, in dim light mode in which the LED is driven by a current less than a current in normal light mode, an oscillation frequency of an oscillation circuit included in the LED drive circuit as compared with the normal light mode.

10. The LED illumination device of claim 9,
wherein the LED drive circuit further includes a switching power supply circuit outputting a DC output voltage and a constant-current power supply circuit that receives the DC output voltage and that outputs the constant current to drive the LED, and reduces, in the dim light mode, at least one of oscillation frequencies of an oscillation circuit included in the switching power supply circuit and an oscillation circuit included in the constant-current power supply circuit as compared with the normal light mode.

11. The LED illumination device of claim 9,
wherein the LED drive circuit detects the dim light mode by detecting a current passing through the LED.

12. The LED illumination device of claim 9,
wherein the LED drive circuit detects the dim light mode by detecting an input current to the LED drive circuit.

13. The LED illumination device of claim 9,
wherein the LED drive circuit detects the dim light mode by an external signal.

14. The LED illumination device of claim 9,
wherein the LED drive circuit detects the dim light mode by detecting an amount of light emitted from the LED.

15. The LED illumination device of claim 10,
wherein the LED drive circuit detects the dim light mode by detecting a current passing through a switching element included in the switching power supply circuit.

16. The LED illumination device of claim 10,
wherein, in the dim light mode, the LED drive circuit does not reduce, when reducing the oscillation frequency of the oscillation circuit included in the switching power supply circuit as compared with the normal light mode, the oscillation frequency of the oscillation circuit included in the constant-current power supply circuit, whereas the LED drive circuit does not reduce, when reducing the oscillation frequency of the oscillation circuit included in the constant-current power supply circuit as compared with the normal light mode, the oscillation frequency of the oscillation circuit included in the switching power supply circuit.
